(19) United States
(12) Patent Application Publication
(10) Pub. No.: US 2012/0132853 A1
(43) Pub. Date: May 31, 2012

(54) METHOD OF PROTECTING MEMBRANES

(75) Inventor: Thorsten Singer, Solingen (DE)

(73) Assignee: QIAGEN GMBH

(21) Appl. No.: 13/321,468

(22) PCT Filed: May 20, 2010
(86) PCT No.: PCT/EP10/56935

§ 371 Date: Feb. 3, 2012

(30) Foreign Application Priority Data
May 25, 2009 (DE) 10 2009 022 513.7

(51) Int. Cl. C09K 3/00

(52) U.S. Cl. 252/189

(57) ABSTRACT

The present invention relates to a method of protecting membranes by treatment with an aqueous solution containing at least one water-soluble, nucleophilic compound, and the use of this aqueous solution for protecting matrices.

### FIELD OF THE INVENTION

The present invention relates to a method and a use for protecting matrices, for example membranes, more particularly silica membranes. The device and the use are, for example, suitable for applications in biochemistry, molecular biology, molecular genetics, microbiology, medical diagnostics or forensic medicine.

### TECHNICAL BACKGROUND

Matrices, more particularly membranes, for example silica membranes, are widespread in the field of biochemistry, molecular biology, molecular genetics, microbiology, medical diagnostics or forensic medicine and are usually used for purifying/isolating biomolecules. A method which is often used is, for example, the use in isolating nucleic acids such as DNA or RNA.

For this purpose, a sample containing the DNA and/or RNA to be isolated is bound to the (purification) matrix in, for example, the presence of a “chaotropic” reagent. The other constituents of the sample can subsequently be removed by rinsing and washing. Subsequently, the DNA or RNA is released and analyzed.

As part of in-house studies by the applicant, it has now become apparent that some matrices, more particularly commercially available matrices, particularly when they are in the form of membranes, give rise to the problem that in some cases the ability to bind nucleic acids decreases over (storage) time. This is particularly the case when they are stored at room temperature or higher temperatures. Although this problem can be minimized by storage at 4° C., it cannot be completely prevented thereby.

### OBJECT OF THE PRESENT INVENTION

An object of the present invention is to at least substantially overcome the described disadvantages apparent from the prior art and, more particularly, to create for a wide range of applications a method and a use which can protect matrices from aging.

The object is achieved by a method as claimed in claim 1 of the present invention. Thus, a method for protecting membranes by treatment with an aqueous solution containing at least one water-soluble, nucleophilic compound is proposed.

The object is likewise achieved by a use as claimed in claim 2 of the present invention. Thus, the use of an aqueous solution containing at least one water-soluble, nucleophilic compound for protecting membranes is proposed.

For the purposes of the present invention, the term “aging” of matrices, such as membranes in particular, is understood to mean the loss of ability of nucleic acids to bind under chaotropic conditions to an appropriate matrix. The inventors suspect that the cause thereof may be the prolonged storage of the matrices in the presence of various plastics, or in the form of ready assembled spin columns. This may result in outgassings of plastics constituents, for example plasticizers or other additives and/or styrenes or short-chain aliphatics. In extreme cases, this may lead to complete hydrophobicity of the matrix, associated with drastic losses of yield in various nucleic acid processing protocols, since it is highly probable that these outgassings can bind to the hydrophilic surface of the matrix.

For the purposes of the present invention, the term “nucleic acid” is understood to mean in particular—but is not limited thereto—naturally occurring, preferably linear, branched or circular nucleic acids such as RNA, more particularly mRNA, single-stranded and double-stranded viral RNA, siRNA, miRNA, snRNA, tRNA, hnRNA or ribozymes, genomic, bacterial or viral DNA (single-stranded and double-stranded), chromosomal and episomal DNA, free-circulating nucleic acid and the like, synthetic or modified nucleic acids, for example plasmids or oligonucleotides, more particularly primers, probes or standards used in PCR, digoxigenin-, biotin- or fluorescent dye-labeled nucleic acids or what are known as LNAs (locked nucleic acids) or PNAs (peptide nucleic acids).

The term “matrices” is understood to mean in particular—but is not limited thereto—solid phases which are capable of reversibly binding biomolecules, preferably nucleic acids. For the purposes of the invention, such a solid phase is preferably a membrane, particularly preferably a silica membrane. However, matrices for the purposes of the invention also include filter materials which have mineral constituents, such as metal oxides, more particularly aluminum oxide, nitrides, carbides, more particularly silicon carbide, or hydrophilic particles capable of forming loose or tight packings.

For the purposes of the present invention, the term “immobilization” is understood to mean in particular—but is not limited thereto—reversible immobilization on a suitable solid phase.

The term “nucleophilic” is understood to mean the ability of a negatively polarized molecule (“a nucleophile”) to attack a positively polarized or charged atom in a molecule with the formation of a covalent bond. Typical nucleophiles are often negatively charged or have at least one free electron pair in a high-energy orbital.

In a preferred embodiment, the water-soluble, nucleophilic compound according to the invention is a negatively charged detergent and/or has at least one molecule having at least two OH groups.

The method according to the invention and/or the use according to the invention involve treatment with an aqueous solution containing at least one water-soluble, nucleophilic compound, since such a compound has similar chemical properties to the solid phase itself and is thus most probably capable of “imitating” the surface thereof, for example the surface of a silica membrane.

The reasons for the surprising effect of the method and/or the use of the present invention are so far still unknown. However, the inventors of the present invention suspect that the method and/or the use of the present invention bring about the capture of the aforementioned offgasings of plastics constituents responsible for the aging of the matrices. They suspect that the water-soluble, nucleophilic compound may possibly bind the outgassings of plastics constituents. In this way, it is the water-soluble, nucleophilic compound according to the invention, instead of the matrix, which is most probably attacked by the outgassings.

Such a method and/or such a use offer at least one of the following advantages for a wide range of applications within the context of the present inventions:
The solid phase or the matrix is protected by means of a simple and very rapid operation, since the treatment is a simple soaking of the matrix in an aqueous solution according to the invention.
The method and/or the use of the present invention are preferably protective (impregnation of the matrix), i.e., the matrix is impregnated prior to storage. Thus, this means there is no additional operation for the end user.
Impregnation ensures consistent quality and performance on the part of the matrix.
For most applications within the context of the present invention, protection is complete to such an extent that it is possible to dispense with storage at cold temperatures.
Reproducibility in the application increases significantly as a result.

In a preferred embodiment of the present invention, the matrices are hydrophilic. In a particularly preferred embodiment of the present invention, the matrices are hydrophilic membranes. The “Boom process” (EP819696) illustrates, with the aid of silica membranes, an example of the binding of nucleic acids to hydrophilic membranes. For selective binding of nucleic acids, samples are lysed in a lysis buffer containing a chaotropic substance, for example guanidinium thiocyanate. Not only are the cells lysed, but proteins are also denatured and inactivated. The nucleic acids are released and bind to the OH groups of the silica membrane. The other constituents of the sample can subsequently be removed by washing. Lastly, the DNA or RNA can be released for subsequent analysis.

Preferred hydrophilic membranes are thus in particular silica membranes, also known as glass fiber filters, quartz wool or glass wool, but also filter membranes with or without functional groups and composed of natural or synthetic organic polymers, such as regenerated cellulose, cellulose acetate, cellulose nitrate, polyamide or poly(ether)sulfone.

Nucleic acids bind to, for example, the silica surface via hydrogen bonds with the Si—OH groups (silanol groups) of the silica membrane. The aforementioned outgassings of plastics constituents can presumably also bind to these Si—OH groups and thus result in hydrophobicity of the matrix. Similarly to the silica membrane by means of the Si—OH groups, the water-soluble compound according to the invention is capable of providing an electron pair for the formation of a covalent bond owing to its nucleophilic character. The inventors suspect that treatment with the aqueous solution according to the invention results in the compound according to the invention, instead of the matrix surface, being attacked by the outgassings of the plastics constituents.

In a preferred embodiment of the present invention, the OH groups according to the invention are alcoholic OH groups. OH⁻, as a classic Lewis base, is nucleophilic. It has free electron pairs which it can provide for bonds.

In a preferred embodiment of the present invention, membranes are used for the immobilization of nucleic acids.

In a preferred embodiment, the method according to the invention is a method for impregnation and/or the use according to the invention is a use for impregnation. The membrane is treated with an aqueous solution according to the invention prior to storage and is protected as a result from the described aging.

In a further preferred embodiment, the method according to the invention and/or the use according to the invention comprise a drying step after treatment with the aqueous solution. This drying step preferably takes place at a temperature of ≧5° C. to ≦45° C., with temperatures of 20° C., 21° C., 22° C., 23° C., 24° C., 25° C., 26° C., 27° C., 28° C., 29° C. or 30° C. being preferred. In principle, there is no upper or lower limit to the temperature range, but temperatures of up to 45° C. are preferred for handling reasons. The duration of the drying step is preferably between ≧1 s and ≦60 min, but in principle there is no upper or lower limit. For handling reasons or manufacturing reasons, times of 1 min, 2 min, 3 min, 4 min or up to 5 min are preferred. This drying step is advantageous for handling reasons, for example in the case of treatment prior to the assembling of spin columns, and/or for storage reasons.

In a preferred embodiment, the water-soluble, nucleophilic compound according to the invention is a solid. Thus, the water-soluble, nucleophilic compound can remain on the matrix surface after a drying step as a thin impregnation layer until use. Owing to the water-soluble character of the nucleophilic compound, a separate wash step to remove the water-soluble, nucleophilic compound is also not necessary, since the compound is dissolved upon contact with the nucleic acid sample and can thus be removed in the customary wash steps of a nucleic acid purification procedure.

In a preferred embodiment, the water-soluble, nucleophilic compound according to the invention having at least one molecule having at least two OH groups is a sugar alcohol. In a particularly preferred embodiment, the water-soluble, nucleophilic compound according to the invention having at least one molecule having at least two OH groups is selected from the group containing sorbitol, xylitol, lactitol, threitol, erythritol, mannitol, isomalt, inositol, palmitate and/or citrate or a mixture thereof.

In a further particularly preferred embodiment, the aqueous solution according to the invention contains at least one mixture of at least one negatively charged detergent and at least one water-soluble, nucleophilic compound having at least one molecule having at least two OH groups.

In a further particularly preferred embodiment, the negatively charged detergent is selected from the group containing fatty alcohol sulfates, more particularly sodium dodecyl sulfate (SDS), and/or alkylbenzenesulfonic acids and/or alkylbenzenesulfonates, more particularly sodium dodecylbenzenesulfonate, benzenesulfonic acid, dodecylbenzenesulfonate, ammonium dodecylbenzenesulfonate, and/or N-lauroylsarcosine (“sarkosyl”) or a mixture thereof.

The water-soluble compound according to the invention is, as has already been elucidated, most probably capable of “imitating” the matrix surface owing to its nucleophilic character. Thus, presumably the compound according to the invention, instead of the matrix surface, is attacked by the outgassings of the plastics constituents.

In a preferred embodiment, the aqueous solution according to the invention additionally contains a compound which prevents the growth of microorganisms. Particularly preferably, the compounds are selected from the group containing sodium azide, thimerosal, phenol, benzyl alcohol and/or cresol.

Treatment with an aqueous solution according to the invention preferably lasts from ≧1 second to ≦60 minutes. In principle, the duration of treatment has no upper limit, but it has been found in most applications that treatment for longer than 5 minutes does not bring about a substantially improved binding ability. Thus, the preferred duration of treatment is 1 min, 2 min, 3 min, 4 min up to 5 minutes.

In addition, treatment with an aqueous solution according to the invention preferably takes place at a temperature of ≧5° C. to ≦45° C., with temperatures of 20° C., 21° C., 22° C., 23° C., 24° C., 25° C., 26° C., 27° C., 28° C., 29° C. or 30° C. being preferred. In principle, the temperature range has no upper or lower limit, but temperatures of up to 45° C. are preferred for handling reasons.

In addition, the pH of the aqueous solution according to the invention is preferably from ≧4.5 to ≦9.5, particularly preferably from ≧6 to ≦8 and very particularly preferably about 7. In other words, the pH of the aqueous solution according to the invention is most preferably essentially neutral.

In addition, the aqueous solution according to the invention is preferably at a concentration of 20.5 to 20%, particularly preferably at a concentration of ≧1 to ≦10% and very particularly preferably at a concentration of to 5%.

The components to be used according to the invention which are mentioned above, claimed and described in the exemplary embodiments are not subject to any particular exceptional conditions with regard to their size, shape, material selection and technical conception, and so the selection criteria known in the field of application can be applied without restriction.

Further details, features and advantages of the subject matter of the invention will be apparent from the dependent claims and also from the description below, the accompanying figures and exemplary embodiments in which—by way of example—multiple possible embodiments and uses of the present invention are illustrated.

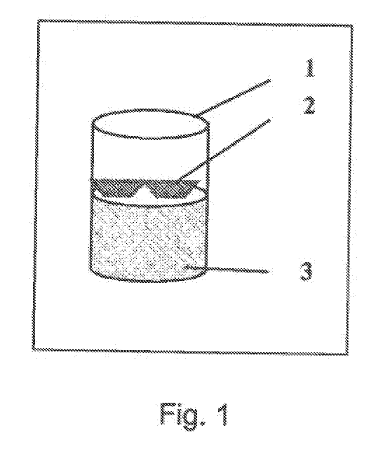

FIG. 1 shows the experimental setup for inducing membrane aging.

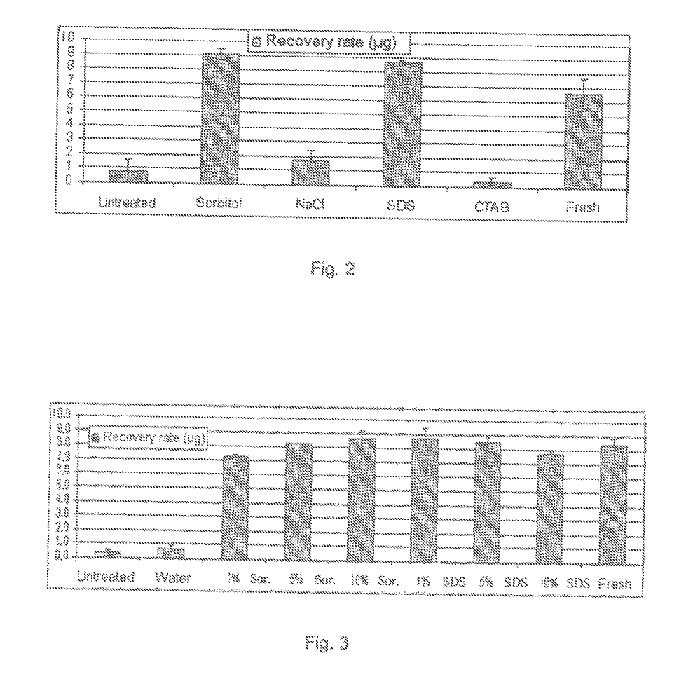

FIG. 2 shows a diagram of the plasmid DNA-binding ability of silica membranes which were pretreated according to the invention, and comparative examples.

FIG. 3 shows a diagram of the plasmid DNA-binding ability of silica membranes which were pretreated with various concentrations of sorbitol or SDS, and comparative examples.

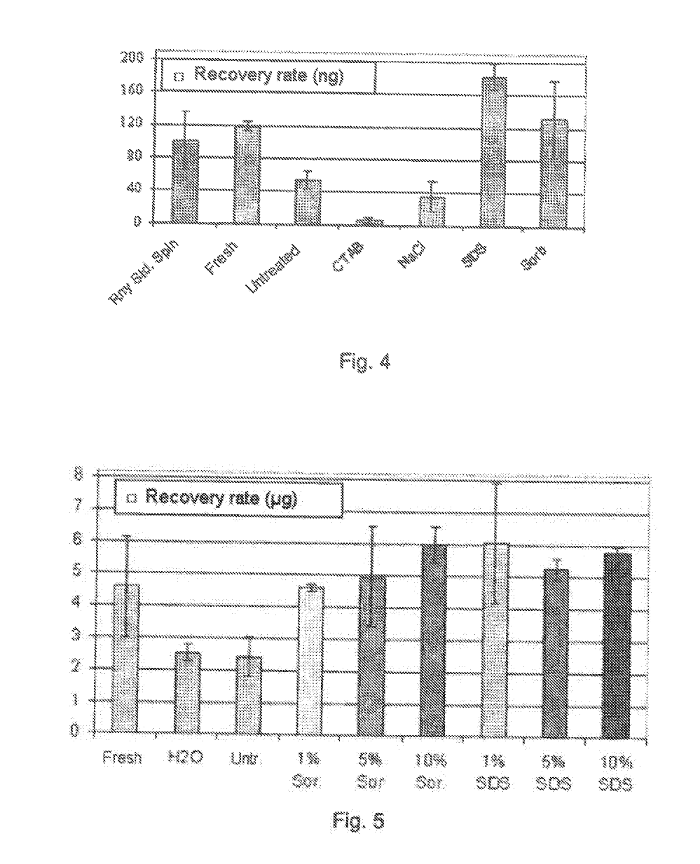

FIG. 4 shows a diagram of the RNA-binding ability of silica membranes which were pretreated according to the invention, and comparative examples.

FIG. 5 shows a diagram of the RNA-binding ability of silica membranes which were pretreated with various concentrations of sorbitol or SDS, and comparative examples.

The present invention is illustrated by the following exemplary embodiments, but is not to be restricted thereto.

The following procedure was adopted:

### EXAMPLE 1

Silica membrane disks (GF51, Pall) were punched out and each soaked in an aqueous solution of the corresponding substance. The corresponding substances (used) are mentioned below. Soaking was carried out for 5 minutes at room temperature, i.e., at about 20° C. The membrane disks were then briefly dried and incubated at 50° C. in the presence of a relatively large number of frits (Vyon F polyethylene, Kopp). The incubation induced aging of the membrane disks. The incubation lasted 7 days (FIG. 2 and FIG. 4) or 3 weeks (FIG. 3 and FIG. 5). The experimental setup for this purpose is shown in FIG. 1. A closed beaker (1) is filled with a large number of frits (3). Open aluminum boats containing the treated membrane disks (2) are then placed on the frits.

The membrane disks were then directly assembled into Mini spin columns prior to the test (for binding ability) (setup from bottom to top: frit/1×GF51 membrane/clamping ring).

For the DNA test, 10 μg of pUC21 plasmid were dissolved in 500 μl of Buffer PB (QIAGEN), applied to the column, and centrifuged through the membrane. This was followed by washing with 700 μl of Buffer PE (QIAGEN), dry centrifugation, and elution with 200 ml of Buffer EB (QIAGEN). The eluates were measured photometrically at 260 nm.

The “recovery rate” of the silica membranes can be found in table 1 and FIG. 2. Shown in each case is the binding ability of a fresh membrane disk, an untreated membrane disk, and a membrane disk pretreated with sorbitol, NaCl, SDS or cetyltrimethylammonium bromide (CTAB).

TABLE 1
Comparison of various chemicals with regard to their
effectiveness in protecting silica membranes from
aging in terms of the binding of plasmid DNA

| Sample | 1st μg/μl | 2nd μg/ml | MV [μg] |
|---|---|---|---|
| Untreated | 1.4 | 0.2 | 0.8 |
| 10% Sorbitol | 9.3 | 8.8 | 9.05 |
| 5M NaCl | 2.2 | 1.2 | 1.7 |
| 20% SDS | 8.6 | 8.8 | 8.7 |
| 15% CTAB | 0.6 | 0.2 | 0.4 |
| Fresh | 5.8 | 7.4 | 6.6 |

MV = Mean value

The results showed that the untreated membranes were highly hydrophobic and have virtually lost their binding ability. Treatment with NaCl or the cationic detergent CTAB also did not provide any improvement.

Membranes which were pretreated with sorbitol and/or SDS according to the present invention have surprisingly retained their binding ability and exhibit no aging effect.

In separate experiments (not shown in FIG. 2), PEG 600 and PEG 4000 were tested as well. For both substances, although the membranes remained hydrophilic, in contrast to untreated membranes, they nevertheless did not exhibit improved binding ability after storage.

The binding ability of silica membranes pretreated with different concentrations (1%, 5% or 10%) of sorbitol or SOS can be found in table 2 and FIG. 3.

TABLE 2
Comparison of different concentrations of SDS and sorbitol
with regard to their effectiveness in protecting silica membranes
from aging in terms of the binding of plasmid DNA

| Sample | 1st μg/μl | 2nd μg/μl | MV [μg] |
|---|---|---|---|
| Untreated | 0.5 | 0.3 | 0.4 |
| H₂O | 0.8 | 0.5 | 0.7 |
| 1% Sorbitol | 7.3 | 7.2 | 7.3 |
| 5% Sorbitol | 8.2 | 8.2 | 8.2 |
| 10% Sorbitol | 9.0 | 8.2 | 8.6 |
| 1% SDS | 9.2 | 8.2 | 8.7 |
| 5% SDS | 8.2 | 8.8 | 8.5 |
| 10% SDS | 7.9 | 7.6 | 7.8 |
| Fresh | 8.1 | 8.7 | 8.4 |

MV = Mean value

The results showed that the untreated membrane disks and the membrane disks soaked in water have virtually completely lost their binding ability. In contrast to this, all the sorbitol- or SDS-soaked membranes were within the range of the unstored reference.

### EXAMPLE 2

The silica membrane disks were pretreated as described in example 1 and assembled into the Mini spin columns.

For the test, 5×10⁵ HeLa cells per preparation were homogenized in 350 μl of Buffer RLT, mixed with the same volume of 70% strength ethanol, applied to the prepared spin columns, and centrifuged through the membranes. The spin columns were processed according to the standard RNeasy procedure (QIAGEN RNeasy Mini Handbook; Protocol: Purification of Total RNA from Animal Cells Using Spin Technology). Elution was carried out in 30 μl of RNase-free water. The eluate was measured photometrically at 260 nm.

The “recovery rate” of the silica membranes can be found in table 3 and FIG. 4. Shown in each case is the RNA-binding ability of a standard RNeasy column (QIAGEN), a fresh silica membrane, an untreated silica membrane, and a silica membrane pretreated with sorbitol, NaCl, SDS or cetyltrimethylammonium bromide (CTAB).

TABLE 3
Comparison of various chemicals with regard to
their effectiveness in protecting silica membranes
from aging in terms of the binding of RNA

| | | | | Standard |
|---|---|---|---|---|
| Sample | 1st ng/μl | 2nd ng/μl | MV [ng] | deviation |
| RNy Std. | 126 | 76 | 101.0 | 35.36 |
| Spin | | | | |
| Fresh | 115 | 123 | 119.0 | 5.66 |
| Untreated | 63 | 47 | 55.0 | 11.31 |
| 15% CTAB | 4 | 8 | 6.0 | 2.83 |
| 5M NaCl | 23 | 49 | 36.0 | 18.38 |
| 20% SDS | 172 | 194 | 183.0 | 15.56 |
| 10% Sorbitol | 164 | 99 | 131.5 | 45.96 |

MV = Mean value; RNy Std. Spin = standard RNeasy column (2 membrane layers)

Surprisingly, as in example 1, the membranes treated with SDS and/or sorbitol according to the present invention again exhibited here no aging effect at all.

By contrast, treatment with NaCl did not show any significant improvement, and treatment with CTAB even resulted in a significant decline in yield.

The RNA-binding ability of silica membranes pretreated with different concentrations (1%, 5% or 10%) of sorbitol or SDS can be found in table 4 and FIG. 5.

TABLE 4
Comparison of different concentrations of SDS and sorbitol
with regard to their effectiveness in protecting silica
membranes from aging in terms of the binding of RNA

| Sample | MV [μg] | Standard deviation |
|---|---|---|
| Fresh | 4.58 | 1.57 |
| H₂O | 2.51 | 0.27 |
| Untreated | 2.41 | 0.62 |
| 1% Sorbitol | 4.60 | 0.10 |
| 5% Sorbitol | 4.97 | 1.58 |
| 10% Sorbitol | 6.01 | 0.54 |
| 1% SDS | 6.07 | 1.89 |
| 5% SDS | 5.25 | 0.33 |
| 10% SDS | 5.80 | 0.16 |

MV = Mean value

All the membranes soaked in sorbitol and/or SDS according to the present invention were within the range of the unstored reference membrane.

1. A method for protecting membranes by treatment with an aqueous solution containing at least one water-soluble, nucleophilic compound.

2. The use of an aqueous solution containing at least one water-soluble, nucleophilic compound for protecting membranes.

3. The method as claimed in claim 1 wherein the water-soluble, nucleophilic compound is a negatively charged detergent and/or has at least one molecule having at least two OH groups.

4. The method of claim 3, wherein the OH groups are alcoholic OH groups.

5. The method of claim 1, wherein the membranes are used for the immobilization of nucleic acids.

6. The method of claim 1, wherein the method is a method for impregnation and/or the use is a use for impregnation.

7. The method of claim 1, wherein the method comprises a drying step after treatment with the aqueous solution.

8. The method of claim 1, wherein the water-soluble, nucleophilic compound is a solid.

9. The method of claim 3, wherein the water-soluble, nucleophilic compound having at least one molecule having at least two OH groups is a sugar alcohol.

10. The method of claim 9, wherein the water-soluble, nucleophilic compound having at least one molecule having at least two OH groups is selected from the group consisting of sorbitol, xylitol, lactitol, threitol, erythritol, mannitol, isomalt, inositol, palmitate citrate and a mixture thereof.

11. The method of claim 3 wherein the negatively charged detergent is selected from the group consisting of fatty alcohol sulfates, sodium dodecyl sulfate (SDS), alkylbenzenesulfonic acids alkylbenzenesulfonates, particularly sodium dodecylbenzenesulfonate, benzenesulfonic acid, dodecylbenzenesulfonate, ammonium dodecylbenzenesulfonate, N-lauroylsarcosine and a mixture thereof.

12. The method of claim 1, wherein the aqueous solution contains at least one mixture of at least one negatively charged detergent and at least one water-soluble, nucleophilic compound having at least one molecule having at least two OH groups.

13. The method claim 1, wherein the aqueous solution additionally contains a compound which prevents the growth of microorganisms.

14. The method of claim 13, wherein the additional compound is selected from the group consisting of sodium azide, thimerosal, phenol, benzyl alcohol and/or cresol.

15. The method claim 1, wherein the treatment lasts from ≧1 second to ≦60 minutes.

16. The method of claim 1, wherein the treatment takes place at a temperature of ≧5° C. to ≦45° C.

17. The method of claim 1, wherein the treatment takes place at a pH of ≧4.5 to ≦9.5.

18. The method of claim 1, wherein the aqueous solution is at a concentration of ≧0.5 to ≦0%.
